(19) United States
(12) Patent Application Publication
(10) Pub. No.: US 2007/0225489 A1
(43) Pub. Date: Sep. 27, 2007

(54) Method for modification of starch, starch and its use

(76) Inventors: Stig-Erik Bruun, Parainen (FI); Hannu Ketola, Hameenlinna (FI); Timo Laine, Turku (FI)

Correspondence Address: JoAnn Villamizar, Patent Department;Ciba Specialty Chemicals Corporation, 540 White Plains Road, P.O. Box 2005, Tarrytown, NY, 10591-9005, US

(21) Appl. No.: 11/784,116

(22) Filed: Apr. 5, 2007

Related U.S. Application Data
(63) Continuation-in-part of application No. 10/488,263, filed on Feb. 27, 2004.

(30) Foreign Application Priority Data
Aug. 28, 2001 (FI) 20011722
Dec. 21, 2001 (FI) 20012544

(51) Int. Cl. C08B 31/00

(52) U.S. Cl. 536/106

(57) ABSTRACT

The invention relates to a method for the modification of starch in such a way that it is suitable for surface sizing at high dry matter contents of >15%, typically >20%, even more than 25%. The modification of starch comprises at least degradation and stabilisation of the starch, whereby the degradation of starch is carried out by means of a chemical treatment, such as hypochlorite oxidation or acid treatment, to such a degree of degradation at which the viscosity of the surface size prepared from the starch, calculated to a dry matter content of 10% and to a temperature of 60° C., still is at >5 mPas, typically >15 mPas, most typically >25 mPas, Brookfield RVTD II 100 rpm. The invention also relates to a starch intended for use in surface sizing at a high dry matter content and its use in surface sizing.

This application is a continuation-in-part of application Ser. No. 10/488,263, filed Feb. 27, 2004, which is a National Stage of International Application No. PCT/FI2002/00699, filed Aug. 28, 2002 herein incorporated entirely by reference.

The present invention relates to a method, a starch and its use, as defined in the preambles of the independent claims presented below. The present invention also relates to a method for the surface sizing of paper or the like, such as paperboard, with a surface size solution prepared from starch, and to the regulation of the porosity of the surface sized paper.

Starches are the most used raw material group in the paper industry, after fibres and pigments. Starch is used, among other things, as a surface size, whereby it is spread on the surface of dried paper.

Starch is a carbohydrate present in nature in all plants, especially in plant seeds, roots and tubers, where it functions as a nutrient reserve for the new growing season. Starch is a glucose polymer, in which anhydroglucose units are linked to each other by an α-D-glucosidic bond. Glucose chains are either linear, amylose, or branched, amylopectin. In a normal case, the proportion of amylose in starch is smaller than that of amylopectin, that is about 20-25%. The size of the starch chains varies according to from which plant the starch originates, and whether it is amylose or amylopectin that is concerned. Amylose chains are smaller than amylopectin chains.

The sizing properties of starch are based on a large number of hydroxyl groups contained in it, which are able to form hydrogen bonds. In a water solution, hydrogen bonds are formed between the hydroxyl groups, whereby starch binds water by means of the hydrogen bonds. During drying, the water molecules are removed and hydrogen bonds are formed between the starch, fibres and other components used in paper making.

Starch is insoluble in cold water. During preparation of a surface size when the mixture of starch and water is heated, the starch begins to dissolve at a certain temperature, which can be seen as a rise in the viscosity of the solution. The viscosity rises further when the heating is continued, until individual starch chains begin to detach from each other, which in turn can be seen as a fall in viscosity. When the solution cools, the starch chains begin to associate again through hydrogen bonds, whereby the viscosity again rises. In a dilute solution the associated starch chains settle on the bottom of the container, but concentrated solutions form a three-dimensional gel. Therefore it has not been possible to use concentrated starch solutions in surface sizing.

Starch solutions have two functional characteristics in conjunction with surface sizing: viscosity and stability. The viscosity of a starch solution depends, among other things, on the average molecular size of starch. In addition to the molecular size, the viscosity of a starch solution is influenced by temperature, dry matter content, that is, concentration, and by the ion concentration of the solution, that is, pH, hardness and conductivity.

The stability of a starch solution in this connection means that starch has a low tendency to bond with itself. As indicated above, in concentrated solutions starch has a tendency to gelatinise when cooling, which is detected as rise in viscosity, as turbidity or as solidifying of the solution. Gelatinisation is mainly caused by rather long linear starch chains, which are easily bonded to each other by means of hydrogen bonds. When starch is degraded, the proportion of short linear starch chains increases, thus preventing the gelatinisation from taking place in a similar manner and increasing the stability of the starch solution. Stability also increases as the branching and the number of side chains increase, so called steric stabilisation.

The stability of the starch solution is determined by preparing a 10% by weight aqueous starch solution, heating the solution to at least 95° C. (e.g. 125° C.), letting the starch to cook for a certain time (the higher the temperature the shorter the time, e.g. about 20 min at 95° C. and about 1.5 min at 125° C.) and then letting the solution cool to room temperature or about 20° C. During this cooling, the Brookfield viscosity is measured at 60° C. After 24 hours at room temperature, the temperature of the starch solution is increased to 60° C. and the viscosity is measured again. If the starch is stable and has not gelatinised during cooling, the difference between these viscosity measurements should be in the range of plus or minus 10%.

The surface sizing of paper aims at influencing the properties of the paper. Surface sizing is carried out with a size press arranged to be in conjunction with the dryer section of a paper machine or in a separate surface sizing unit. After the addition of surface size, the paper web or the like is conveyed through a dryer section, in which the added surface size dries.

Surface sizing aims at binding fines and fillers to the paper surface and influencing the paper's properties, such as hydrophobicity, porosity, strength, etc. Nowadays surface sizing is performed with starch solutions whose dry matter is about 8-12%. In surface sizing, the aim is to add a certain constant amount of starch solution, surface size, onto the surface of paper or the like.

In surface sizing starch is nowadays added as a starch solution or surface size solution having typically a dry matter content of not more than about 10%. It has not been possible to increase the dry matter content as it would lead to a rise in the viscosity of the starch solution and to runnability and contamination problems resulting therefrom. A starch solution having a high viscosity does not necessarily run and spread in the desired manner, but may lead to uneven surface sizing, to the formation of stripes or causing web breaks in the sizer. In addition, there is a risk that the viscosity of the starch solution will increase further when the solution possibly cools e.g. during a process break. In such a case, the solution may stick, for example in pipelines and in storage containers.

Due to the low dry matter content it has been necessary to feed a relatively thick surface size solution layer onto the paper web in order to achieve the desired surface size layer in the dry paper. Because of this, it has thus also been necessary to feed onto the paper a large amount of water, which has had to be removed from the paper web by drying after the surface sizing stage. Drying requires a large amount of energy and a relatively large dryer section suitable for drying. In addition, drying is time-consuming. All the above-mentioned factors give rise to costs.

Due to the low dry matter content and viscosity of the surface size, it has been necessary to use a grooved spreading rod in surface sizing for transferring the required amount of surface size onto the paper web.

It is known to degrade the starch used for surface sizing in order to lower the viscosity of the starch solution. If an attempt is made to run an ordinary surface size containing such starch at a high dry matter with a surface size application device, such as a film transfer device, for example, numerous problems are encountered. The film-forming capacity of the surface size weakens, which results in uneven surface sizing on the paper or paperboard surface and impaired surface sizing quality. An uneven sizing result, for its part, causes breaks on the machine and contamination. There is also a risk of the surface size solidifying in the pipelines, which will lead to time-consuming cleaning operations.

The object of the present invention is, therefore, to achieve an improvement to the above-mentioned problems.

The object is to provide an improved method for the modification of starch to make it suitable for surface sizing.

Another object is to provide an improved surface sizing method for paper.

The object is also to provide an improved modified starch.

A further object is to provide a new use of starch in surface sizing and a new method for regulating paper porosity.

In order to achieve the above-mentioned objects, the present invention is characterised by what is disclosed in the characterising parts of the independent claims presented hereafter.

A typical method according to the invention for modifying starch thus comprises the modification of starch to suit it for surface sizing carried out at high dry matter contents of >15, typically >20, even >25 weight % (wt. %) of the surface size. For example, dry matter content of the surface size may range from greater than 15 wt. % to about 35 wt. % or even to 40 wt. %. The starch modification comprises at least degradation and stabilisation of the starch, whereby starch degradation is carried out by means of hypochlorite oxidation or acid treatment, only to such a degree of degradation at which the viscosity of the surface size prepared from the starch still remains >5 mPas, typically >15 mPas, most typically >25 mPas. The viscosity may even be more than 30 mPas. The viscosity of the surface size may vary from greater than 5 mPas to as high as 3000 mPas. Preferably the viscosity will range from greater than 5 mPas to less than about 1000 mPas, and more preferably from greater than 5 mPas to less than about 300 mPas or greater than 5 mPas to less than about 100 mPas The viscosity for the above is calculated to a dry matter content of 10% and to a temperature of 60° C. The viscosity was measured with a Brookfield RVTD II 100 rpm measuring device, using a suitable measuring head.

For starch degradation according to the invention, hypochlorite oxidation can be used preferably, as hypochlorite oxidation simultaneously stabilises starch to some extent due to the formation of carboxyl groups, reducing the starch's tendency to form hydrogen bonds and reducing the starch's tendency to raise the viscosity of the starch solution, that is, of the surface size solution. In this manner, less stabilising agents are needed, which is advantageous for cost reasons, or alternatively, better stability is achieved with the same amount of stabilising agent. In some cases (e.g. when the dry matter content of the surface size is below 25 wt. %) hypochlorite oxidation may give sufficient stabilisation and thus comprises both modifications (degradation and stabilisation).

According to the invention, the degradation of starch can also be carried out using another chemical treatment, such as e.g. hydrogen peroxide oxidation.

According to the invention, the degradation of starch can also be carried out chemically by biochemical means, i.e. enzymatically. Then it is preferable to stablise the starch before degradation, the latter taking place e.g. at the paper mill just before use.

According to a third preferred embodiment of the invention, starch can be degraded chemically by means of an acid. This concerns preferably mineral acid, especially hydrochloric acid. Sulphuric acid and/or nitric acid may also be used.

In most cases, it is preferable to stabilise starch, either prior to degradation or after degradation. Starch can be stabilised using various different stabilising methods. Starch can thus typically be stabilised by esterification and/or etherification, such as acetylation and/or hydroxyalkylation. The stabilisation of starch can be further strengthened by cross-linking, such as cross-linking with adipic acid.

Starch is stabilized (i.e. its tendency to degradation is lowered) always when part of the hydroxyl groups are substituted. Thus hypochlorite oxidation both degrades and stabilizes as hypochlorite forms carboxyl groups which stabilize the product. Every modification that replaces hydroxyl groups stabilizes as the starch has lower possibilities to form hydrogen bonds between chains.

Stabilisation enables the use of less degraded, that is, preferably less oxidised starch. Cationisation of starch also creates stabilisation, as substitution of hydroxylic groups is made during cationisation.

Degradation of starch is preferably carried out only to such a degree of degradation at which the viscosity of the surface size prepared from the starch remains, under the prevailing conditions of use, that is, at temperature ranging from 45 to 55° C. and at dry matter content of >15%, at least at 80 mPas, typically at >100 mPas.

According to the invention, starch intended for use in surface sizing at high dry matter content of >15 wt. %, typically >20% wt., even >25% wt., has thus been degraded to such a degree of degradation at which the viscosity of the surface size prepared from the starch, calculated to a dry matter content of 10% and to a temperature of 60° C., is at >5 mPas, typically >15 mPas, most typically >25 mPas and at <3000 mPas, typically <1000 mPas, most typically <100 mPas, Brookfield RVTD II 100 rpm. In this case the starch has preferably been degraded by means of hypochlorite oxidation and stabilised by means of esterification and/or etherification, such as acetylation and/or hydroxyalkylation. Further stabilisation can be achieved by cross-linking with adipic acid in conjunction with acetylation, as disclosed in publication WO 99/12977. The starch may additionally have been further stabilised by cationisation with a chemical substance prepared from epichlorohydrin and trimethylamine, and additionally by using at least one of the following substances monomethylamine, dimethylamine or N,N,N′,N′-tetramethylethylene-diamine for the stabilisation of starch.

Surface size prepared from starch modified according to the invention can be used in surface sizing carried out by film transfer technology. Such film transfer devices include e.g. Metso Paper Inc.'s OptiSizer (SymSizer) and Voith Paper GmbH's SpeedSizer. Due to the high dry matter content of >15% of the surface size, among other things, a smooth rod or blade can be used in film transfer for spreading the surface size on the film transfer surface, typically on a roll. The diameter of the rod is preferably as small as possible. In practice, a rod having a diameter of about 15-35 mm is possible, but a rod with a diameter of less than 10 mm would in some cases be preferable.

Surface size prepared from starch modified according to the invention can be used in surface sizing carried out with a surface size application device which is arranged in conjunction with a paper or board machine and which is also suitable for coating.

When applying the invention, surface size can be spread in considerably smaller amounts of solution than when spreading conventional surface sizes with a considerably lower dry matter content. When applying the invention in surface sizing, a surface size solution layer of less than 10 g/m², typically <7 g/m², is spread on the web, at least on one of its sides.

Previously, e.g. surface size with a dry matter of 10% has had to be spread in a quantity of 100 g/m², when the desired amount of starch in the dry surface size layer has been 10 g/m². When using surface size according to the present invention at a high dry matter of >25%, the size solution is spread accordingly in a quantity of >40 g/m², which has a considerable effect on the production efficiency of the surface sizing machine and on the drying energy requirement. The runnability of the machine is also improved, as less water is added to the paper web when the dry matter of the surface size is high, in other words, the paper web is not wetted as much as when using previously used surface sizes. This makes it possible to raise the speed e.g. of such old paper machines in which the effect of the drying unit situated after the surface size unit has previously been a production speed restricting factor.

When applying the invention, that is, when using in surface sizing a starch that has been degraded and stabilised according to the invention, surface sizing can be carried out at a higher temperature than previously, typically at application temperatures of >60° C., and even at application temperatures ranging from 80° C. to 99° C. Evaporation of water is low when the dry matter of the surface size solution is high. Additionally, surface size containing degraded and stabilised starch according to the invention can cool on the surface of the roll without solidifying and it is transferred as a film onto the surface of the paper. The roll material is chosen to suit these higher temperatures.

When using starch modified according to the invention at a high dry matter content, the properties of the paper, e.g. the paper's surface properties, can be regulated in conjunction with paper making. The invention can be applied, for example, in such a manner that the porosity of a paper web or the like, which has been surface sized with starch modified according to the invention, is regulated by regulating the starch content in the surface size. Previously, porosity has been regulated by regulating a property of the base paper, e.g. by means of pulp refining. When applying the invention, porosity does not need to be regulated, e.g. in connection with a grade change, by adjusting changing the refining process, which is considerably more difficult than regulating the dry matter of the surface size. Applying the present invention thus also makes it possible to achieve the same end result at less cost and obtain a better result, as there is less no need to refine the expensive fibre.

When using a surface size solution with a high dry matter according to the invention, the wet surface size layer to be spread is also considerably thinner compared to a conventional surface size layer. Since, according to the invention, there is thus less water spread on the surface of the paper with the surface size solution, which water may be absorbed into the paper, the starch contained in the surface size is not able to migrate into the paper before drying. This has the consequence that the starch remains on the surface of the paper or paperboard, which has an advantageous effect on the surface strength and stiffness of the paper or paperboard being treated. By treating only the paper surface, it is possible to regulate the surface properties as desired. One of the important surface properties of paper and paperboard is porosity, which is easy to regulate by using a starch modified according to the invention, as the invention enables the use of a wide surface size dry matter range.

The present invention also relates to a method for the surface sizing of paper or the like with a size application device using a surface size solution prepared from a starch that has been modified at least by degradation and stabilisation. In this case, starch has been degraded according to the invention by means of a chemical treatment, such as e.g. hypochlorite oxidation, to such a degree of degradation at which the viscosity of a surface size solution prepared from the starch, when calculated to a dry matter content of 10% and to a temperature of 60° C., is at >5 mPas, typically >15 mPas, most typically >25 mPas, and at <3000 mPas, typically <1000 mPas, most typically <100 mPas, Brookfield RVTD II 100 rpm. The dry matter content of the surface size solution is >15 wt. %, typically >20 wt. %, most typically >25% and preferably <40 wt. %, more preferably <35 wt. %. The amount of surface size solution used in surface sizing according to the invention is generally <10 g/m², typically <7 g/m², even about 56 g/m², at least on one side of the web. The amount of surface size on the dry web is in this case <3 g/m², at least on one side of the web. The amount of surface size in a dry web may be substantially smaller, such as about 1 g/m²/side.

In a method according to the invention for the surface sizing of paper or the like with a size application device using a surface size solution prepared from a starch that has been modified at least by degradation and stabilisation, the surface size solution may comprise, in addition to starch, required additives, such as e.g. hydrophobing agents. The proportion of additives in the surface size solution is, however, usually low compared to the amount of starch. The dry matter of the surface size solution is thus calculated as total dry matter of all components, but in practice, due to the small amounts of additives, the total dry matter is almost directly proportional to the dry matter of starch, if it were calculated in the surface size solution separately.

The different sides of the base paper to be surface sized may be different due, among other things, to an uneven distribution of fillers and moisture in the paper or paperboard web. This can cause, for example, paper curling. Previously, tailoring of the surface size solutions to be added to the different sides of the paper according to the paper's surface properties has been limited, or even impossible, because it has only been possible to regulate the dry matter of the surface size within a very narrow range. Traditionally, it has not been possible to change the dry matter of the surface size solution by more than by 1-2%. The present invention allows regulation of the dry matter of the surface size solution within a considerably wider range, so that the dry matter may vary from 5 to 10%. In this manner, the invention allows the possibility in surface sizing, of adding to the first side of the paper, a surface size whose dry matter clearly differs from that of the surface size to be added to the second side of the base paper. The invention thus provides an easy and simple way to prevent and control the detrimental curling of paper. The differences in the pore size distribution of the base paper on the different sides of the paper can also be equalised in a simple manner, without compromising runnability, by adding to the different sides of the paper a surface size whose dry matter has been tailored to suit the pore size distribution of that side of the paper.

In one embodiment of the invention, the dry matter contents of the surface size solutions to be added to the first and second sides of the paper in surface sizing are preferably different, whereby the difference between the dry matters of the surface size solutions is typically more than 3%, preferably 5-10%.

The surface sizing process can be further enhanced and ensured, for example, by limiting the cooling of the surface size solution and/or the increase in its dry matter content during surface sizing. The cooling of the surface size solution during surface sizing can in this case be limited, for example,
by limiting the extent to which cooling room-air comes into contact with the surface size, or
by introducing heat into the size press, in which case the increase in the viscosity of the surface size solution can be controlled better than before.

The surface sizing process can, on the other hand, also be enhanced by limiting the increase in the dry matter content of the surface size solution during surface sizing, by limiting the evaporation of water from the surface size solution, for example, by maintaining the humidity of the air coming into contact with the surface size solution at a higher level than the humidity of the ambient air. The surface size application device may, for example, be enclosed, in a hood or the like. At the same time, moist air and/or steam at a suitable temperature may be fed inside the enclosure in order to prevent any premature cooling of the surface size and evaporation of water from the size.

Applying the invention achieves numerous advantages, some of which are mentioned in the following.

When starting, according to the invention, to use a surface size with a higher dry matter content, the feed of surface size onto the web may be reduced from the previous, and the use of starch may be reduced, which gives the web better strength.

In view of the end result of the surface sizing, it is advantageous if a starch with as high a viscosity as possible can be used, which is possible when applying the invention. The advantages of a high dry matter content relate to both production, economy and investments. There is no need to lower the speed of the application unit when going over from paste application to surface size application. The speed of the surface sizing unit does not slow down despite the higher dry matter content of the size, and thus does not form bottlenecks in production.

One of the advantages of the present invention is that when using a surface size prepared from a starch according to the invention in surface sizing, the dry matter content of the surface size can be kept as high as possible in the situation of use, without impairing the functional properties of the surface size. When using such a surface size, the amount of water added to the paper web can be reduced. This enables substantial energy savings at the process stage following the surface sizing during which the added surface size is dried, because the higher the dry matter content of the surface size added to the paper web, the less water needs to be removed from the paper web by evaporating. At the same time, the length of the paper machine's dryer section can be reduced, which allows for savings in investment costs and for reducing the size of the hall space required for the paper machine.

Another advantage of the present invention is that, when the amount of water to be added to the paper web during surface sizing is reduced by using a surface size prepared from a starch according to the invention and having a high dry matter content, the properties of the paper can be improved and at the same time, the number of web breaks can probably also be reduced. Web breaks are reduced because the paper web does not get wet to the same extent as when using a conventional surface size, and the web remains stronger.

It has traditionally been necessary to treat the base paper with different agents that increase hydrophobicity prior to the surface sizing of the paper, in order to prevent excessive and detrimental absorption of the water contained in the surface size into the base paper. Due to its low dry matter, traditional surface size solution has been added in large quantities to the paper surface and at the same time, in fact, considerable amounts of water have been added to the paper. As the amount of water being added to the paper with the surface size is considerably reduced with the help of the present invention, the hydrophobicity-increasing treatment of the base paper may be reduced or it may possibly be completely eliminated.

It can also be mentioned as one of the advantages of the present invention that the use properties of the surface size solution are improved when the dry matter content is high. A high dry matter content reduces, for example, foaming of the surface size, in other words, fewer small gas bubbles are formed in the surface size solution according to the invention than in a traditional starch containing surface size solution having a low dry matter content. When foaming is reduced, the quantity of surface-active anti-foaming agents to be added to the surface size may be substantially reduced, which contributes to lowering the total chemical costs. At the same time, the runnability of the paper machine is improved.

By using for surface sizing a surface size with a high dry matter content, almost complete film transfer, 95-99%, can also be achieved while at the same time a very thin film thickness can be achieved in surface sizing. Surface sizing speed does not cause any restrictions either.

Furthermore, one of the advantages of the invention is that when the dry matter content of the surface size is high, penetration of the starch contained in the surface size into the paper web diminishes. The starch thus remains on the surface of the paper web, which is desirable. The starch on the paper surface improves the paper's surface properties, such as surface strength and stiffness.

One of the advantages of the present invention is also that the surface sizing may be carried out at a higher temperature, which contributes to lowering the viscosity of the surface size prepared from starch.

A further advantage of the invention is that it reduces the evaporation and the fall in temperature of surface size occurring at the surface sizing roll. Preventing the evaporation occurring on the roll also contributes to improving the stability of the surface size's viscosity and prevents any unintended, undesirable increase in viscosity occurring at the roll as a result of evaporation and cooling.

A further advantage of the invention is that by regulating the dry matter content of the surface size, the surface properties of the paper to be manufactured, such as porosity, can be controlled. This makes it possible, by using a surface size prepared from a starch according to the invention and having a high dry matter in the surface sizing method according to the invention, to manufacture two or more paper grades having a different porosity by using the same base paper and by changing the dry matter content of the surface size.

The following example illustrates the invention, without intending to be restrictive in nature; parts and percentages are by weight, unless otherwise indicated.

Paper web (base paper) is surface sized with starch solution on a pilot machine with film transfer unit (OptiSizer). The web is produced from pulp having fiber basis 100% Eucalyptus and has basis weight of 75 g/m². The surface sizing takes place at machine speed 1000 m/min. The amount of the surface size is 1.4 g/m² on both sides of the web.

Trial starch (starch according to the invention) is wheat starch which has been cationized to DS (degree of substitution) 0.18 with 2,3-epoxypropyltrimethylammonium chloride (2.7% calculated from the amount of starch), oxidized with sodium hypochlorite (3.5% calculated as active Cl₂) and treated with acetic anhydride (4%) containing dissolved adipic acid (0.15%). The Brookfield viscosity of the starch solution at 10% dry solids and 60° C. is 70 mPas.

The reference starch is cationized and hydrogen peroxide oxidized wheat starch with the same DS and viscosity as the trial starch.

The base paper is surface sized with both starch solutions at dry solids of 8% and 18% and the web dried thereafter to moisture content of 4.5%.

The reference starch solution could be used at dry solids content of 8%. At 18% surface sizing is impossible to carry out due to thickening of the surface size leading to streaks in the paper web and gelling in the sizer and at the film transfer roll.

The trial starch solution has no runnability concerns during the trial with dry solids content of either 8% or 18%.

Compared to the reference starch solution at 8%, the trial starch solution at 18% decreased drying energy need by 40% and increased surface strength of the paper by 10%.

The object is not to limit the invention to the embodiments presented above, but to apply it broadly within the scope of protection determined by the following claims.

1. A method for the surface sizing of paper or board, by means of a size application device, with a surface size solution prepared from a starch that has been modified at least by degradation and stabilisation, wherein
the starch has been degraded to such a degree of degradation at which the viscosity of the surface size solution prepared from the starch, calculated to a dry matter content of 10% and to a temperature of 60° C., still is at >5 mPas, Brookfield RVTD II at 100 rpm, and that
the dry matter content of the surface size solution is >15%.

2. The method of claim 1, wherein said starch is degraded by means of hypochlorite oxidation.

3. The method of claim 1, wherein said starch is stabilised by means of esterification and/or etherification.

4. The method of claim 1, wherein the stabilisation of said starch is enhanced by means of cross-linking.

5. The method of claim 1, wherein said starch is stabilised by cationisation.

6. The method of claim 1, wherein said starch is cationised by using a chemical substance that has been prepared from epichlorohydrin and trimethylamine, and additionally at least one member of the group consisting of monomethylamine, dimethylamine and N,N,N′,N′-tetramethylethylene-diamine.

7. The method of claim 1, wherein said starch is degraded by means of an acid.

8. The method of claim 1, wherein the degradation of the starch is carried out to such a degree of degradation at which the viscosity of the surface size prepared from the starch, under conditions of use where the temperature is 45-55° C. and the dry matter content is >15%, is at least at 80 mPas.

9. The method according to claim 1, wherein the amount of the surface size solution in surface sizing is <10 g/m² at least on one side of the paper or board.

10. The method according to claim 1, wherein the amount of surface size on the paper or board is <3 g/m², at least on one side of the paper or board.

11. The method of claim 1, wherein the dry matter contents of the surface size solution added to a first and second side of the paper or board is different, whereby the difference between the dry matter content of the surface size solution is more than 3% based on weight.

12. The method according to claim 1, wherein the cooling of the surface size solution and/or the increase of its dry matter content during surface sizing are/is limited.

13. The method of claim 12, wherein the cooling of the surface size solution during surface sizing is limited
by limiting the extent to which cooling room-air comes into contact with the surface size,
and/or
by introducing heat into the size press,
for controlling the increase of the viscosity of the surface size solution.

14. The method or claim 12, wherein the increase in the dry matter content of the surface size solution during surface sizing is limited by limiting the evaporation of water from the surface size solution by maintaining the humidity of the air coming into contact with the surface size solution at a higher level than the humidity of the ambient air.

15. The method of claim 1, wherein the surface size application device has been enclosed with a hood.

16. The method of claim 1, wherein the dry matter content of the surface size solution is at least 20 wt. %.

17. A method for regulating the porosity of a paper or board web by applying a modified starch according to claim 1, wherein the porosity is regulated by regulating the starch content in the surface size.

18. A paper or board surface size comprising a starch at high dry matter content of >15%, which starch has been modified at least by degradation and stabilisation, wherein the starch has been degraded to a degree of degradation at which the viscosity of the surface size prepared from the starch, calculated to a dry matter content of 10% and to a temperature of 60° C., is at >5 mPas, as measured by a Brookfield RVTD II at 100 rpm.

19. The size according of claim 18, wherein the viscosity of the size prepared from the starch, where the dry matter content is >15% and the temperature is 45-55° C., is >80 mPas.

20. The size of claim 18, wherein the starch has been modified by degradation by means of hypochlorite oxidation.

21. The size of claim 18, wherein the starch has been stabilised by means of esterification and/or etherification.

22. The size of claim 18, wherein the starch has been stabilised by cross-linking with adipic acid.

23. The size of claim 18, wherein the starch has been stabilised by esterification and/or etherification and further stabilised by means of cross-linking.

24. The size of claim 18, wherein the starch has been stabilised by cationisation.

25. The size of claim 18, wherein the starch has been cationised by means of a chemical substance that has been prepared from epichlorohydrin and trimethylamine, and additionally at least one member of the group consisting of monomethylamine, dimethylamine or N,N,N′,N′-tetramethylethylene-diamine, for the stabilisation of the starch.

26. The size of claim 18, wherein the starch has been degraded by means of an acid.
